(19) United States
(12) Patent Application Publication
(10) Pub. No.: US 2025/0303854 A1
(43) Pub. Date: Oct. 2, 2025

(54) CLUTCH WITH BRAKING MECHANISM FOR EASE OF GEAR SHIFTING

(71) Applicant: DANA ITALIA S.R.L., Arco (IT)

(72) Inventors: Santosh BHALEGHARE, Pimpri Chinchwad (IN); Sachin MALI, Sangli (IN); Amith ANNAPPA, Pimpri Chinchwad (IN)

(21) Appl. No.: 18/617,392

(22) Filed: Mar. 26, 2024

(51) Int. Cl. B60K 17/02; B60K 17/08

(52) U.S. Cl. CPC B60K 17/02; B60K 17/08

(57) ABSTRACT

Systems and methods are provided for a clutch with braking mechanism comprising: a dual-position shifting sleeve in face sharing contact with a radially aligned spring loaded detent, wherein the shifting sleeve includes a first groove adapted to receive the detent in a high speed position and a second groove adapted to receive the detent in a low speed position; and a first axially aligned piston and a second axially aligned piston adapted to actuate a first brake plate and a second brake plate, respectively, when the shifting sleeve is in an intermediate position between the high speed position and the low speed position.

### TECHNICAL FIELD

The present description relates generally to systems and methods for a clutch with braking mechanism for case of gear shifting in a transmission.

### BACKGROUND AND SUMMARY

A powertrain of a vehicle may include a gearbox which may utilize engagement of clutches to shift between drive gears or gearsets. For example, a clutch may be used in a two-speed gear box to transfer between a high speed gearset and low speed gearset.

Dog clutches with interlocking elements such as teeth, dogs, and the like, may be used in transmissions to shift gears. However, conventional dog clutches have associated drawbacks. For example, conventional dog clutches may cause torque shock to a system, especially when the rotating components are not synchronized prior to engagement. Additionally, clashing noise may occur when shifting between gearsets. As a result, wear on parts of dog clutches, such as shifting sleeves, may occur, leading to a demand for replacement of such parts.

Thus, exemplary embodiments are disclosed herein that address at least some of the issues described above. In one example, a clutch with braking mechanism comprises: a dual-position shifting sleeve in face sharing contact with a radially aligned spring loaded detent, wherein the shifting sleeve includes a first groove adapted to receive the detent in a high speed position and a second groove adapted to receive the detent in a low speed position; and a first axially aligned piston and a second axially aligned piston adapted to actuate a first brake plate and a second brake plate, respectively, when the shifting sleeve is in an intermediate position between the high speed position and the low speed position. In this way, a braking mechanism, including actuating the first brake plate and the second brake plate during shifting between gearsets, may reduce speed variation of gears which are engaged by the shifting sleeve to prevent clashing and wear of the shifting sleeve and the gears. Additionally, the braking mechanism may be deactivated after shifting is accomplished, such that braking occurs during shifting and does not occur when a gearset is engaged (when the detent is received by the first groove or the second groove). Thus, clashing noise and wear of shifting sleeves and gear teeth may be prevented in a two-speed gearbox. Further, the clutch with braking mechanism disclosed herein may be implemented in other applications, such as a dual power take off, for example in agricultural tractors.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a schematic depiction of an example vehicle.

FIG. 2 shows a schematic depiction of an example hydrostatic transmission system of a vehicle, including a two-speed gearbox and a clutch.

FIGS. 3A and 3B show power flow through the hydrostatic transmission system for a high gear mode and low gear mode, respectively, of the clutch.

FIGS. 4A and 4B show cross sectional views of a gearbox with a clutch with braking mechanism according to the present disclosure.

FIGS. 5A, 5B, and 5C show a high gear mode, a shifting position, and low gear mode, respectively, of the clutch with braking mechanism.

FIGS. 6A and 6B show cross sectional views of parts of the gearbox.

FIGS. 7A and 7B show perspective views of parts of the gearbox.

FIG. 8 shows a flowchart of a method for operating a clutch with braking mechanism.

### DETAILED DESCRIPTION

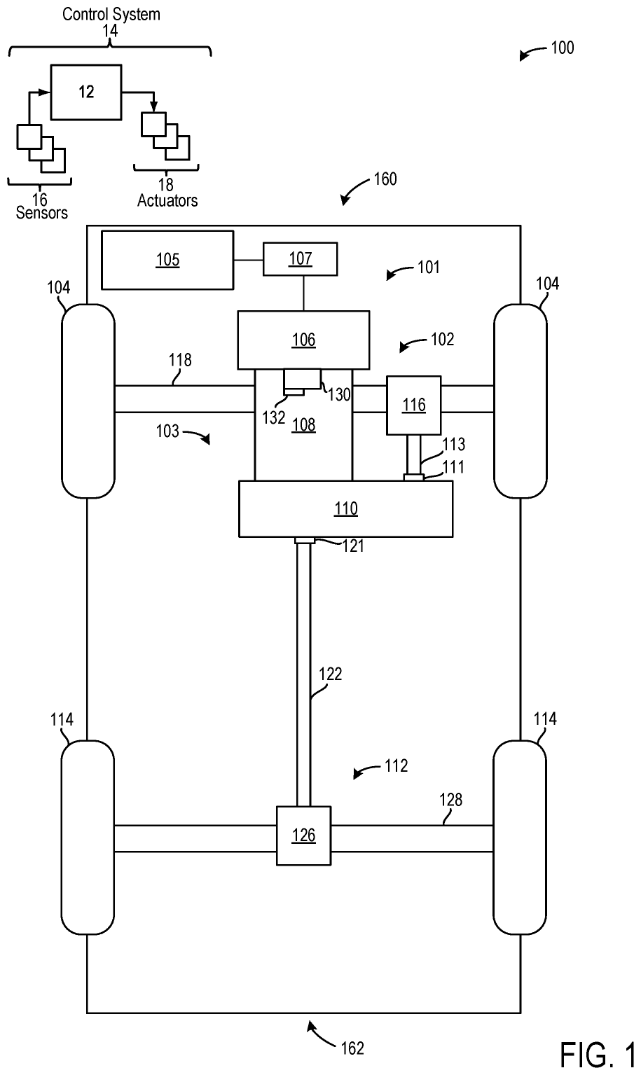

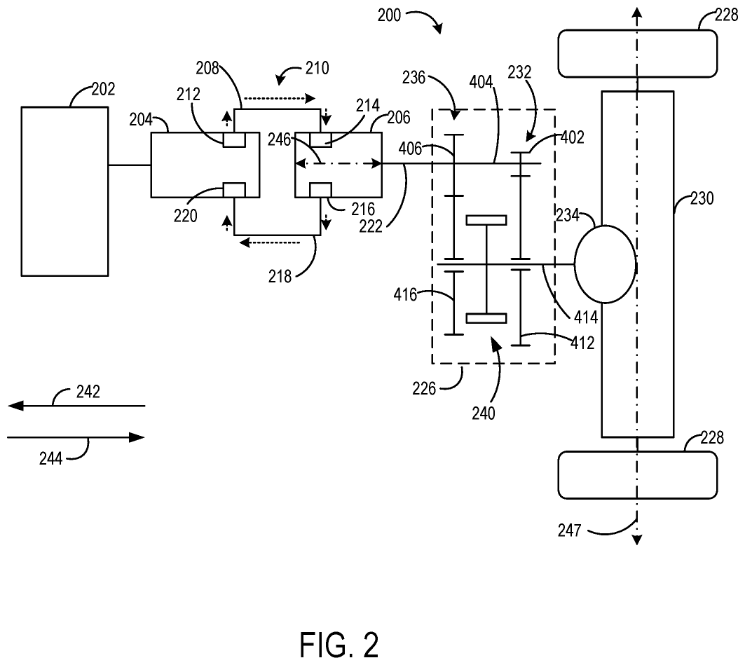

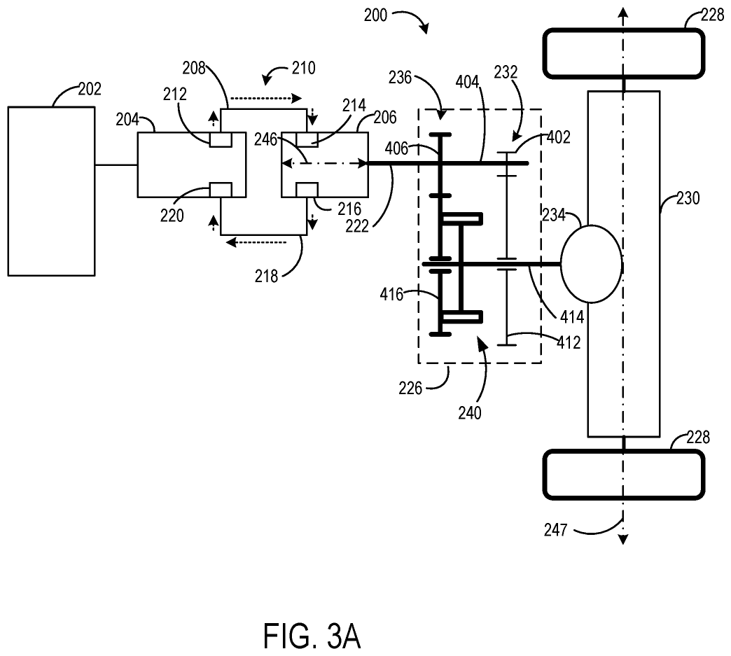

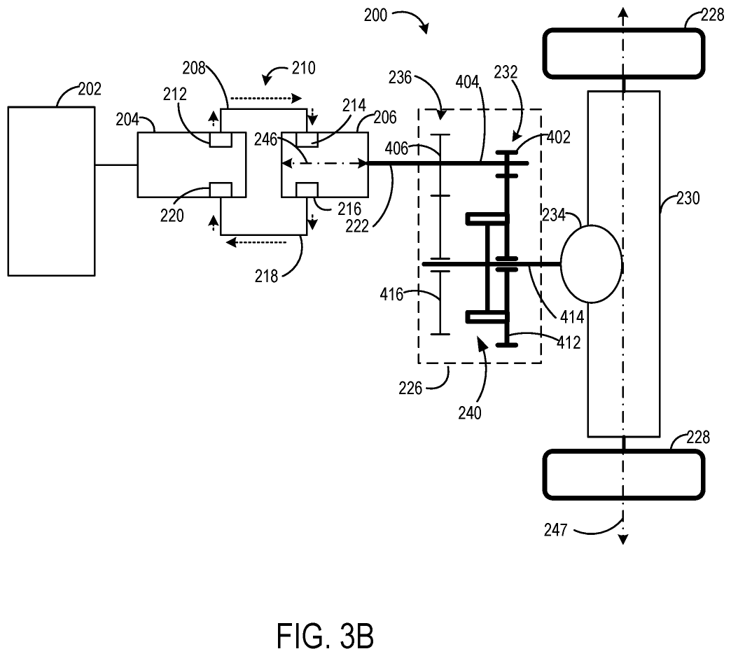

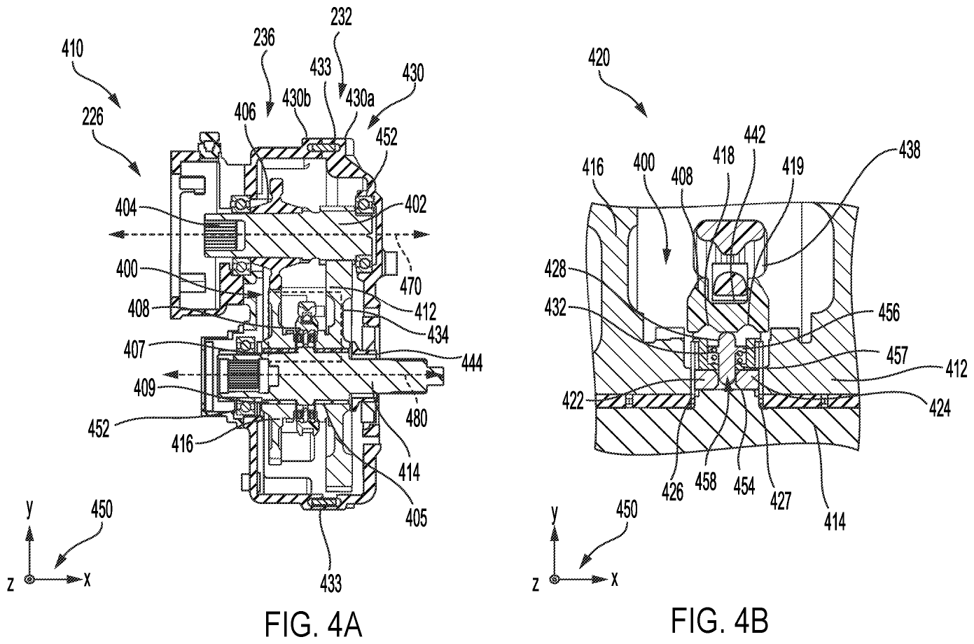

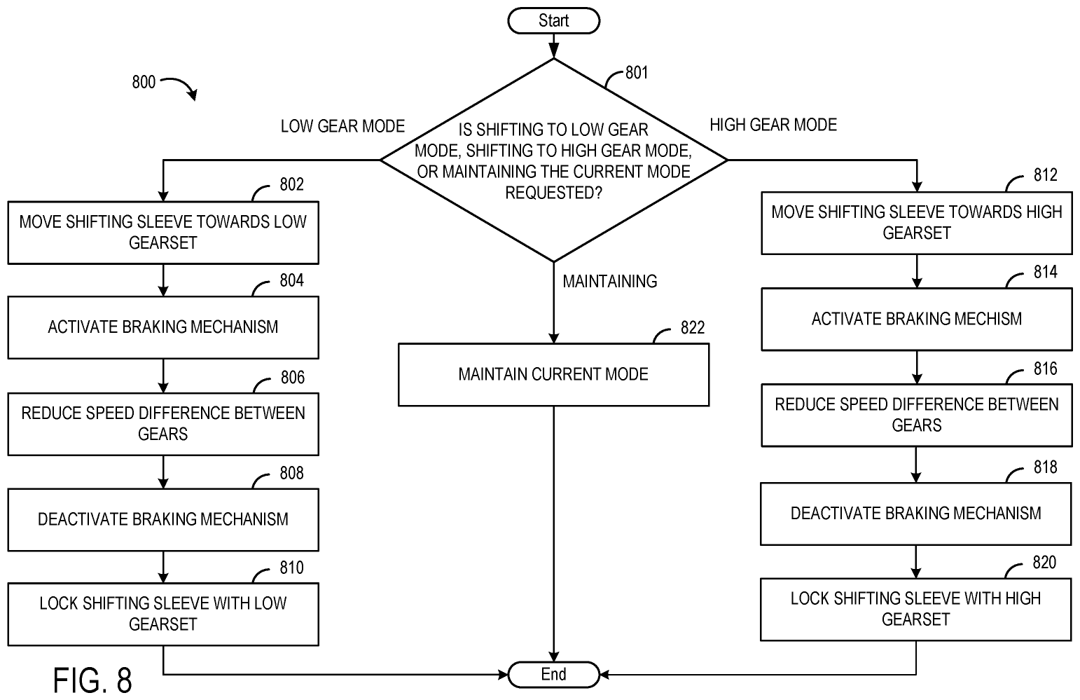

The following description relates to systems and methods for a clutch with braking mechanism. The clutch with braking mechanism may be used in a gearbox of a vehicle, such as the vehicle schematically depicted in FIG. 1. The gearbox may be a two-speed gearbox, and the clutch with braking mechanism may be used to change between a high gear set and a low gearset. The high gearset may be a high speed gearset and the low gearset may be a low speed gearset. For example, the two-speed gearbox may be incorporated into a hydrostatic transmission system such as the hydrostatic transmission system schematically depicted in FIG. 2. In such an example, power flow through the hydrostatic transmission system may follow paths shown in FIGS. 3A and 3B for a high gear mode (wherein the clutch with braking mechanism is engaged with the high gearset) and a low gear mode (wherein the clutch with braking mechanism is engaged with the low gearset), respectively. An example of the two-speed gearbox and clutch with braking mechanism is shown in different views and positions (e.g., modes) in FIGS. 4A-7B. A flowchart of a method of operating a clutch with braking mechanism according to the present disclosure, such as the clutch with braking mechanism shown in FIGS. 4A-7B, is shown in FIG. 8.

It is also to be understood that the specific assemblies and systems illustrated in the attached drawings, and described in the following specification are exemplary embodiments of the inventive concepts defined herein. For purposes of discussion, the drawings are described collectively. Thus, like elements may be commonly referred to herein with like reference numerals and may not be re-introduced.

Turning first to FIG. 1, a vehicle 100 is depicted having a powertrain 101 and a drivetrain 103. The powertrain comprises a prime mover 106 and a transmission 108. The prime mover 106 may be an internal combustion engine and/or an electric motor, for example, and is operated to provide rotary power to the transmission 108. The transmission 108 may be of various types, such as a manual transmission, an automatic transmission, or a continuously variable transmission. The transmission 108 receives the rotary power produced by the prime mover 106 as an input and outputs rotary power to the drivetrain 103 in accordance with a selected gear or setting.

In one example, the transmission 108 may be a hydrostatic transmission including a two-speed gearbox with a clutch 130 to change between speed modes. It will be appreciated that the clutch 130 of FIG. 1 is a general depiction of where the clutch 130 and the location presented within the transmission 108 is representative and not meant to be limiting. Further, as described above, more than one clutch may be included in the transmission 108. Additional details of the clutch 130 are provided further below. Furthermore, the hydrostatic transmission, as described above, is a non-limiting example of one or more clutches incorporated into a transmission.

The prime mover 106 may be powered via energy from an energy storage device 105. In one example, the energy storage device 105 is a battery configured to store electrical energy. An inverter 107 may be arranged between the energy storage device 105 and the prime mover 106 and configured to adjust direct current (DC) to alternating current (AC). In one example, the vehicle 100 is an electric vehicle. In other examples, the vehicle 100 may be a hybrid vehicle, and/or the vehicle 100 may be powered by a combustion engine.

The vehicle 100 may be a commercial vehicle, light, medium, or heavy duty vehicle, a passenger vehicle, an off-highway vehicle, and/or utility vehicle. Additionally or alternatively, the vehicle 100 and/or one or more of its components may be used in industrial, locomotive, military, agricultural, and aerospace applications.

In some examples, such as shown in FIG. 1, the drivetrain 103 includes a first axle assembly 102 and a second axle assembly 112. The first axle assembly 102 may be configured to drive a first set of wheels 104, and the second axle assembly 112 may be configured to drive a second set of wheels 114. In one example, the first axle assembly 102 is arranged proximate to a front end 160 of the vehicle 100 and thereby comprises a front axle, and the second axle assembly 112 is arranged proximate to a rear end 162 of the vehicle 100 and thereby comprises a rear axle. The drivetrain 103 is shown in a four-wheel drive configuration, although other configurations are possible. For example, the drivetrain 103 may include a front-wheel drive, a rear-wheel drive, or an all-wheel drive configuration. Further, the drivetrain 103 may include one or more tandem axle assemblies. As such, the drivetrain 103 may have other configurations without departing from the scope of this disclosure, and the configuration shown in FIG. 1 is provided for illustration, not limitation. Furthermore, the vehicle 100 may include additional wheels that are not coupled to the drivetrain 103.

In some four-wheel drive configurations, such as shown in FIG. 1, the drivetrain 103 includes a transfer case 110 configured to receive rotary power output by the transmission 108. A first driveshaft 113 is drivingly coupled to a first output 111 of the transfer case 110, while a second driveshaft 122 is drivingly coupled to a second output 121 of the transfer case 110. The first driveshaft 113 (e.g., a front driveshaft) transmits rotary power from the transfer case 110 to a first differential 116 of the first axle assembly 102 to drive the first set of wheels 104, while the second driveshaft 122 (e.g., a rear driveshaft) transmits the rotary power from the transfer case 110 to a second differential 126 of the second axle assembly 112 to drive the second set of wheels 114. For example, the first differential 116 is drivingly coupled to a first set of axle shafts 118 coupled to the first set of wheels 104, and the second differential 126 is drivingly coupled to a second set of axle shafts 128 coupled to the second set of wheels 114.

In some examples, additionally or alternatively, the vehicle 100 may be a hybrid vehicle including both an engine an electric machine each configured to supply power to one or more of the first axle assembly 102 and the second axle assembly 112. For example, one or both of the first axle assembly 102 and the second axle assembly 112 may be driven via power originating from the engine in a first operating mode where the electric machine is not operated to provide power (e.g., an engine-only mode), via power originating from the electric machine in a second operating mode where the engine is not operated to provide power (e.g., an electric-only mode), and via power originating from both the engine and the electric machine in a third operating mode (e.g., an electric assist mode). As another example, one or both of the first axle assembly 102 and the second axle assembly 112 may be an electric axle assembly configured to be driven by an integrated electric machine.

The vehicle 100 may further include a control system 14. The control system 14 is shown receiving information from a plurality of sensors 16 and sending control signals to a plurality of actuators 18. As one example, sensors 16 may include at least one clutch sensor 132 for monitoring a position of the clutch 130. Other sensors such as pressure, temperature, air/fuel ratio, and composition sensors when the prime mover 106 includes the engine, may be coupled to various locations in the vehicle 100. The plurality of actuators may include valves controlling flow of hydraulic fluid through the clutch 130. The control system 14 may include a controller 12 which may receive input data from the various sensors, process the input data, and trigger the plurality of actuators 18 in response to the processed input data, based on instruction or code programmed therein, corresponding to one or more routines. In particular, the controller 12 may be a microcomputer, including microprocessor units, input/output ports, an electronic storage medium for executable programs and calibration values such as a read only memory chip, random access memory, keep alive memory, and a data bus.

Turning to FIG. 2, a schematic layout of a hydrostatic transmission system 200 is shown. For example, the hydrostatic transmission system 200 may be incorporated into a vehicle, such as the vehicle 100 of FIG. 1. Further, the vehicle in which the hydrostatic transmission system 200 may be employed may be a hybrid vehicle, and thus may include an engine 202. The engine 202 may be coupled to a pump 204 (e.g., a hydraulic pump) such that the pump 204 is powered by the engine 202. Flow of oil through the pump 204 and motor 206 may cause rotation of components of a gearbox 226 which may be drivingly coupled to wheels 228 of the vehicle via a crown wheel pinion and differential 234 and an axle 230. For example, the gearbox 226 may be a two-speed gearbox. The crown wheel pinion may transfer rotation to the axle 230 (e.g., from a horizontal axis to a vertical axis) and the differential may allow the wheels 228 to operate at different rotational speeds. Thus, pressurized fluid may actuate rotation of the wheels 228 and therefore movement of the vehicle 100. For example, the axle 230 may be a rear axle and the wheels 228 may be rear wheels. In other examples, the axle 230 may be a front axle and the wheels 228 may be front wheels. For example, the vehicle may be driven by an operator either in a first direction (e.g., in a direction indicated by arrow 242) or in a second direction that is opposite the first direction (e.g., in a direction indicated by arrow 244). The first direction and the second direction may be general directions that are non-limiting, and may depend on an axis of rotation 247 of wheels of the vehicle. For example, by user input (e.g., via a steering wheel) the vehicle may be turned at an angle from the first direction and the second direction. For purpose of the description below, the first direction and the second direction may be radially aligned with the wheels 228, perpendicular to the axis of rotation 247.

When the vehicle is driven in the first direction (e.g., the direction indicated by arrow 242), low-pressure oil may be pressurized at the pump 204, and the resulting high-pressure oil may be delivered to a motor 206 via a first fluidic coupling 208 in a direction shown by arrows 210. High-pressure oil may exit the pump 204 from an output port 212 of the pump 204, and enter the motor 206 via an input port 214 of the motor 206. The high-pressure oil may drive rotation of components (e.g., a rotor) of the motor 206, thus reducing pressure of the oil as work is done on the motor 206 to generate torque. The depressurized oil may return to the pump 204 by exiting an output port 216 of the motor 206, following a second fluidic coupling 218, and entering the pump 204 via an input port 220 of the pump 204. In this way, rotation of the motor 206 to prompt movement of the vehicle (via the gearbox 226) may be actuated by pressurized oil from the pump 204.

Rotation of the motor 206 may include rotation of a motor output shaft 222 of the motor 206. The motor output shaft 222 may be rotationally coupled to an input shaft 404 of the gearbox 226 via flange connection, splined connection, bolts, and/or the like. In other examples, the input shaft 404 may be formed integrally with the motor output shaft 222. The gearbox 226 may be a two-speed gear box, such that the gearbox 226 includes a high gearset 236 with a relatively high output rotational speed, and a low gearset 232 with a relatively low rotational output speed.

The high gearset 236 may comprise a first high gear 406 and a second high gear 416. The low gearset 232 may comprise a first low gear 402 and a second low gear 412. The high gearset 236 and the low gearset 232 may have different gear ratios. For example, the high gearset 236 may have a lower gear ratio than the low gearset 232, resulting in higher rotational speed of the second high gear 416 than the second low gear 412. A clutch 240 may shift the gearbox between a high gear mode wherein the high gearset 236 is engaged (e.g., rotationally coupled with the output shaft 414), and a low gear mode wherein the low gearset 232 is engaged. In at least some examples, the high gear mode may be a high speed mode and the low gear mode may be a low speed mode. The clutch 240 is shown in a shifting position in FIG. 2, wherein neither the high gearset 236 nor the low gearset 232 is engaged. For example, the clutch 240 may be a clutch with braking mechanism according to the present disclosure, such as the clutch with braking mechanism 400 described below with reference to FIGS. 4A-7B.

When the vehicle is driven in the second direction (e.g., the direction indicated by arrow 244), oil may flow in opposite directions of the arrows 210 along the first fluidic coupling 208 and the second fluidic coupling 218. Pressurized (e.g., high-pressure) oil may exit the pump 204 from the input port 220 and enter the motor via the output port 216. Thus, the motor 206 may rotate in an opposite direction from driving in the first direction. For example, if the motor 206 rotates clockwise about an axis of rotation 246 when driving in the first direction, the motor 206 rotates counterclockwise about the axis of rotation 246 when driving in the second direction. Consequently, the wheels 228 may rotate oppositely when driving in the first direction compared to driving in the second direction. For example, if the wheels 228 rotate clockwise about an axis of rotation 247 when driving in the first direction, the wheels 228 rotate counterclockwise about the axis of rotation 247 when driving in the second direction.

Turning to FIG. 3A, the hydrostatic transmission system 200 is shown in the high gear mode with the clutch 240 engaged with the high gearset 236. Power flow through the hydrostatic transmission system 200 is shown in bold lines, with torque generation in the motor 206 being transferred to the input shaft 404 via the motor output shaft 222. Because the clutch 240 is engaged with the high gearset 236, power flows therethrough to the output shaft 414. The output shaft 414 then transfers power to the axle 230 and the wheels 228, thus moving the vehicle in the first direction or the second direction as described above. In examples wherein the high gear mode is a high speed mode, the wheels 228 may rotate with higher rotational speed and may experience lower torque compared to the low gear mode.

Turning to FIG. 3B, the hydrostatic transmission system 200 is shown in the low gear mode with the clutch 240 engaged with the low gearset 232. Power flow through the hydrostatic transmission system 200 is again shown in bold lines, with torque generation in the motor 206 being transferred to the input shaft 404 via the motor output shaft 222. Because the clutch 240 is engaged with the low gearset 232, power flows therethrough to the output shaft 414. The output shaft 414 then transfers power to the axle 230 and wheels 228, thus moving the vehicle in the first direction or the second direction as described above. In examples wherein the low gear mode is a low speed mode, the wheels 228 may rotate with lower rotational speed and may experience greater torque compared to the high gear mode. In this way, a mode may be determined, for example by a controller such as the controller 12 of FIG. 1, based on operating conditions.

Shifting of the clutch 240 may occur when a vehicle incorporating the hydrostatic transmission system 200 (e.g., the vehicle 100 of FIG. 1) is stationary (e.g., the wheels 228 are not rotating) such that the output shaft 414 does not rotate. However, if the pump 204 continues to deliver flow and drive the motor 206 while the vehicle is stationary, the input shaft 404, first high gear 406, first low gear 402, second high gear 416, and second low gear 412 may continue to rotate. Thus, a difference in rotational speeds of the second high gear 416 and the second low gear 412 occurring when the clutch 240 is shifting (e.g., not engaged with either of the second high gear 416 or the second low gear 412) and the output shaft is stationary may cause clashing of the shifting sleeve and gears upon engagement thereof, and thus result in wear on the aforementioned parts over time. The clutch 240 may be configured with a braking mechanism, as is further explained with reference to FIGS. 4A-8 below, such that the difference in gear rotational speeds during shifting may be reduced, thus reducing wear on the clutch and gears and delaying a demand for replacement thereof.

FIG. 4A shows a cross section view 410 of an exemplary embodiment of the gearbox 226 including a clutch with braking mechanism 400. Reference axes 450 are also shown, and may be used for comparison to orientations of views shown in FIGS. 4A-7B. A dog clutch with braking mechanism, such as the clutch with braking mechanism 400, may be used to reduce a difference in rotational speeds (e.g., synchronize rotation) of gears such that clashing and wear of parts upon engaging a gearset (e.g., the high gearset 236 or the low gearset 232) with the output shaft 414 is reduced (e.g., prevented). For example, shifting between the high gearset 236 and the low gearset 232 may occur when the vehicle is stationary such that the output shaft 414 does not rotate (e.g., when the output shaft 414 is rotationally stationary). The clutch with braking mechanism 400 may reduce rotation of the input shaft 404 and gears splined to the input shaft 404 (e.g., the first high gear 406 and the first low gear 402) when shifting between the high gearset 236 and the low gearset 232 until the input shaft 404 is also stationary. Thus, the clutch with braking mechanism 400 may reduce a difference in rotational speeds of the input shaft 404 and the output shaft 414. In this way, the clutch with braking mechanism 400 may promote smooth engagement upon engaging with the high gearset 236 or the low gearset 232.

As described above, the gearbox 226 may include the input shaft 404 and the output shaft 414, where torque may be transferred from the input shaft 404 to the output shaft 414 via either the high gearset 236 or the low gearset 232. The clutch with braking mechanism 400 may be configured to engage either the high gearset 236 or the low gearset 232 by rotationally coupling the second high gear 416 or the second low gear 412, respectively, with the output shaft 414. A housing 430 may comprise a first piece 430a and a second piece 430b, wherein the first piece 430a and the second piece 430b may be held together (e.g., in face sharing contact) by fasteners 433 such that the housing 430 encloses elements of the gearbox 226 including the first high gear 406, the first low gear 402, the second high gear 416, the second low gear 412, the clutch with braking mechanism 400, at least a portion of the input shaft 404, and at least a portion of the output shaft 414.

The input shaft 404 and the output shaft 414 may each be supported by one or more bearings 452 such that the input shaft 404 and the output shaft 414 may be allowed to rotate relative to the housing 430 about a first axis of rotation 470 and a second axis of rotation 480, respectively. The first high gear 406 and the first low gear 402 may be rotationally coupled to the input shaft 404 such that the first high gear 406, the first low gear 402, and the input shaft 404 rotate with approximately the same rotational speed about the first axis of rotation 470. In some examples, the first high gear 406 and/or the first low gear 402 may be formed integrally with the input shaft 404.

The second high gear 416 may be positioned relative to the first high gear 406 such that teeth of the second high gear 416 mesh with teeth of the first high gear 406. In this way, the second high gear 416 may be engagingly coupled with the first high gear 406, such that rotation of the second high gear 416 is driven by the first high gear 406 and thus dependent on rotation of the input shaft 404. However, the rotational speed of the second high gear 416 may not be the same as the rotational speed of the input shaft 404 and the first high gear 406 due to the first high gear 406 and the second high gear 416 having different radii and/or number of teeth. Similarly, the second low gear 412 may be positioned relative to the first low gear 402 such that teeth of the second low gear 412 mesh with teeth of the first low gear 402. In this way, the second low gear 412 may be engagingly coupled with the first low gear 402, such that rotation of the second low gear 412 is driven by the first low gear 402 and thus dependent on rotation of the input shaft 404. However, the rotational speed of the second low gear 412 may not be the same as the rotational speed of the input shaft 404 and the first low gear 402. For example, the first low gear 402 and the second low gear 412 may have different radii and/or number of teeth.

Additionally, the second high gear 416 and the second low gear 412 may rotate with different rotational speeds from one another, thus allowing for transmission of two different rotational speeds to the output shaft 414 (depending on engagement of the clutch with braking mechanism 400) for a given rotational speed of the input shaft 404. For example, the difference in rotational speeds of the second high gear 416 and the second low gear 412 may occur due to the difference in gear ratios of the two gearsets. For example, the high gearset 236 may have a lower gear ratio than the low gearset 232, thus resulting in higher rotational speed of the second high gear 416 than the second low gear 412.

The second high gear 416 and the second low gear 412 may be coupled to the output shaft 414 via first bearing 409 and second bearing 405. For example, the first bearing 409 and second bearing 405 may be needle bearings. The first bearing 409 and second bearing 405 may circumferentially surround and be in face sharing contact with the output shaft 414, and may be axially fixed such that the first bearing 409 and second bearing 405 may not move axially relative to the output shaft 414. For example, the first bearing 409 may be axially fixed between one of the bearings 452 and a protrusion 407 of the output shaft 414. Likewise, the second bearing 405 may be axially fixed between the protrusion 407 and a retainer 444. The retainer 444 may further restrict axial movement of the second low gear 412. The second high gear 416 and the second low gear 412 may circumferentially surround and be in face sharing contact with the first bearing 409 and the second bearing 405, respectively.

In this way, the second high gear 416 and the second low gear 412 may be allowed to rotate freely about the second axis of rotation 480 relative to the output shaft 414 when the clutch with braking mechanism 400 is in the shifting position. The clutch with braking mechanism may be rotationally coupled to the output shaft 414. When the clutch with braking mechanism 400 is in the high gear mode (e.g., engaged with the high gearset 236), the second high gear 416 may be rotationally coupled to the output shaft 414 while the second low gear 412 may remain not rotationally coupled to the output shaft 414. When the clutch with braking mechanism 400 is in the low gear mode (e.g., engaged with the low gearset 232), the second low gear 412 may be rotationally coupled to the output shaft 414, while the second high gear 416 may remain not rotationally coupled to the output shaft 414.

As described above, shifting of the clutch with braking mechanism 400 may occur when a vehicle (e.g., vehicle 100 of FIG. 1) is stationary such that the output shaft 414 does not rotate, however in some examples, the input shaft 404 may continue to rotate when the clutch is in a shifting position. Thus the first high gear 406, the second high gear 416, the first low gear 402, and the second low gear 412 may continue to rotate such that the second high gear 416 and the second low gear 412 rotate with different rotational speeds. Thus, the clutch with braking mechanism 400 may reduce the difference in rotational speeds of the second high gear 416 and second low gear 412 during shifting by activating the braking mechanism.

A section 434 of the cross section view 410 is shown in an expanded view 420 in FIG. 4B. The clutch with braking mechanism 400 is shown in expanded view 420, including a shifting sleeve 408, a first piston 422, a second piston 424, a first brake plate 426, a second brake plate 427, a detent 428, and one or more springs 432. There may be a plurality of spring loaded detents and corresponding pistons arranged radially about the output shaft 414, wherein the number may depend on a demanded braking force. For example, a larger vehicle may demand greater braking, while a smaller vehicle may demand relatively lower braking force and therefore fewer detents and corresponding pistons. The shifting sleeve 408 may be moved along a direction parallel with the x-axis to move the clutch with braking mechanism 400 between the shifting position, high gear mode, and low gear mode. For example, the shifting sleeve 408 may be a dual-position shifting sleeve, wherein the shifting sleeve 408 may be in either a first position when in the high gear mode, or a second position when in the low gear mode. The first position may be referred to herein as a high speed position and the second position may be referred to herein as a low speed position. The shifting sleeve 408 may also have an intermediate position, wherein the intermediate position occurs between the first position and the second position. The intermediate position may also be referred to herein as a shifting position. Consequently, the detent 428 may move radially with respect to the output shaft 414 and shifting sleeve 408, resulting in axial movement of the first piston 422 and the second piston 424 along a piston groove 454 that may activate and deactivate the braking mechanism. In this way, axial movement of the shifting sleeve 408 may translate to radial movement of the detent 428, and the radial movement of the detent 428 may translate to axial movement of the first piston 422 and the second piston 424 in order to shift modes of the clutch with braking mechanism 400. Thus, the braking mechanism may be actuated by axial movement of the shifting sleeve 408.

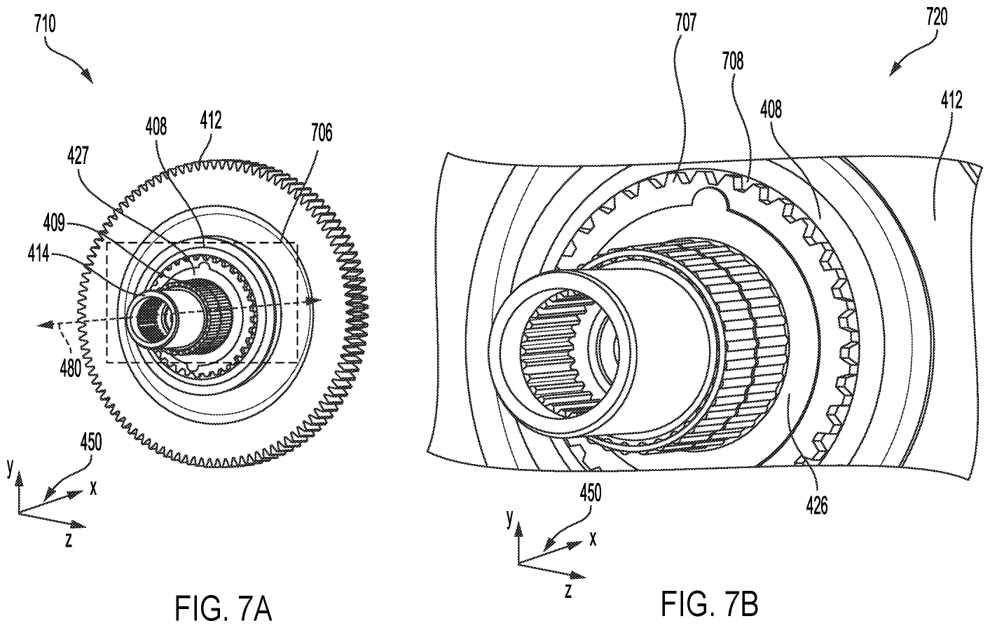

The shifting sleeve 408 may be ring shaped and positioned radially around the output shaft 414. Turning briefly to FIGS. 7A and 7B, a perspective view 710 and an enlarged view 720 of elements of the gearbox 226 are respectively shown, wherein the enlarged view 720 shows section 706 of the perspective view 710. As shown in FIGS. 7A and 7B, the shifting sleeve 408 may rotationally couple to the output shaft 414 via teeth. For example, teeth 707 of the protrusion 407 may extend radially outwards from the protrusion 407 away from the second axis of rotation 480. Shifting sleeve teeth 708 may extend radially inwards towards the second axis of rotation 480. Teeth 707 may interlock with shifting sleeve teeth 708 such that the shifting sleeve 408 and the output shaft 414 are rotationally coupled.

Returning to FIGS. 4A and 4B, the shifting sleeve 408 may include a recess 442 adapted to receive a shifting fork 438. The shifting fork 438 may not be rotationally coupled to the shifting sleeve 408. Further, the shifting fork 438 may be rotationally fixed (e.g., to the housing 430) such that the shifting fork 438 does not rotate about any axis. Further, the shifting fork 438 may not move in a z-direction or y-direction. The shifting fork 438 may move axially in order to shift gears. Axial movement of the shifting fork 438 may actuate the shifting sleeve 408. Axial movement of the shifting sleeve 408 may occur according to movement of the shifting fork 438. The shifting sleeve 408 may be axially fixed to the shifting fork 438. For example, the shifting fork 438 may move axially towards the negative x-direction to engage the high gearset 236, and the shifting fork may move axially towards the positive x-direction to engage the low gearset 232. The shifting sleeve 408 may further include a first groove 418 and a second groove 419, wherein the first groove 418 and the second groove 419 may be adapted to receive the detent 428 in the high gear mode and the low gear mode, respectively. Thus, the first groove 418 may be adapted to receive the detent 428 when the shifting sleeve 408 is in the low speed position, and the second groove 419 may be adapted to receive the detent when the shifting sleeve 408 is in the high speed position. The first groove 418 and the second groove 419 may be placed such that the shifting sleeve 408 is symmetrical. The first groove 418 and the second groove 419 may allow the shifting sleeve 408 to be a dual-position shifting sleeve wherein a first position includes the first groove 418 receiving the detent 428 and a second position includes the second groove 419 receiving the detent 428. When the clutch with braking mechanism 400 is in the shifting position as shown in FIG. 4B, the detent 428 is not positioned in either of the first groove 418 or the second groove 419. In this way, the low gearset 232 may be engaged when the first groove 418 receives the detent 428, the high gearset 236 may be engaged when the second groove 419 receives the detent 428, and the braking mechanism may be activated when neither the high speed gearset 236 or the low speed gearset 232 are engaged.

The detent 428 may be spring loaded. For example, the springs 432 may each be positioned with a first end connected to a radially inwards facing surface (e.g., radially towards the second axis of rotation 480) of a protrusion 456 of the detent 428 and a second end connected to a surface 457 of the protrusion 407 facing radially outwards from the axis of rotation 480. Further, the spring may be adapted to apply force on the detent 428 radially away from the second axis of rotation 480 such that the detent 428 is in face sharing contact with the shifting sleeve 408 in the high gear mode, shifting position, and low gear mode.

The detent 428 may be adapted to extend through a hole 458 such that an end of the detent 428 may enter the piston groove 454 and be in face sharing contact with the first piston 422 and the second piston 424. The detent 428 may maintain a space between the first piston 422 and the second piston 424 such that the first piston 422 and the second piston 424 are not in face sharing contact in the high gear mode, low gear mode, or shifting position.

Because the detent 428 is not positioned in either of the first groove 418 or the second groove 419 in the shifting position as shown in FIG. 4B, the detent 428 may be closer to the second axis of rotation 480 than in the low gear mode or the high gear mode. In this way, the springs 432 may be relatively more compressed in the shifting position than in the high gear mode or low gear mode. Further, the first piston 422 and the second piston 424 may be in face sharing contact with the first brake plate 426 and the second brake plate 427, respectively. Further still, the first brake plate 426 may be in face sharing contact (e.g., pressed against) the second high gear 416 and the second brake plate 427 may be in face sharing contact (e.g., pressed against) the second low gear 412. The first brake plate 426 may be a high friction material interposed between the second high gear 416 and the protrusion 407 of the output shaft 414. Similarly, the second brake plate 427 may be a high friction material interposed between the protrusion 407 and the second low gear 412. Thus, face sharing contact of the first brake plate 426 with the first piston 422 and the second high gear 416, and face sharing contact of the second brake plate 427 with the second piston 424 and the second high gear 416, in the shifting position may generate friction to reduce a difference in rotational speeds of the second high gear 416 and the second low gear 412. Radial movement of the detent 428 may cause axial movement of the first piston 422 and the second piston 424 to actuate the first brake plate 426 and the second brake plate 427, respectively. When the first brake plate 426 and the second brake plate 427 are actuated, rotational speeds of the second high gear 416 and the second low gear 412 may be synchronized. In this way, smooth shifting of gears from the high gear mode to the low gear mode and vice versa may be promoted by the braking mechanism being activated when not in high gear mode or low gear mode (e.g., in the shifting position).

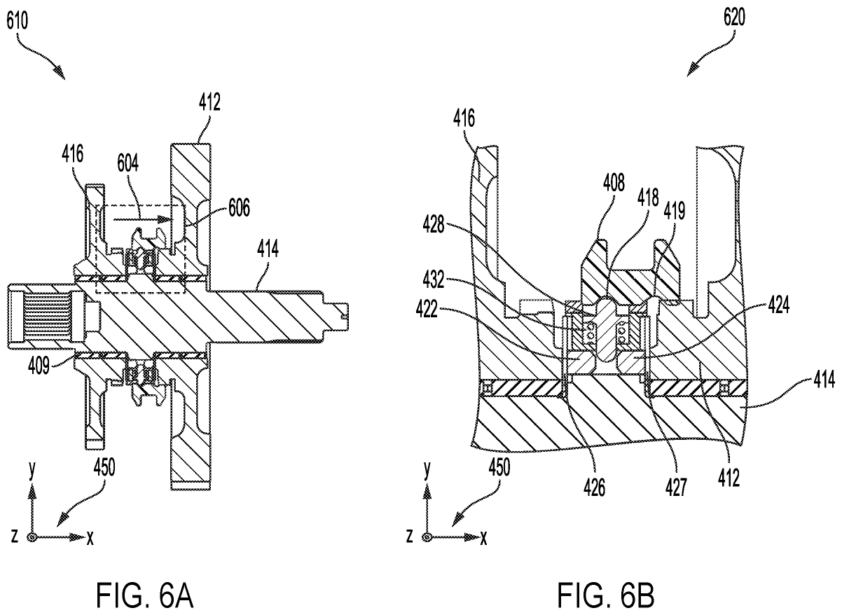

Turning to FIGS. 6A and 6B, a cross section view 610 and an enlarged view 620 are respectively shown of the clutch with braking mechanism 400 in low gear mode, wherein the enlarged view 620 shows section 606 of the cross section view 610. An arrow 604 shows the direction in which the shifting sleeve 408 may be moved to reach the low gear mode from the shifting position shown in FIGS. 4A and 4B or the high gear mode. The shifting sleeve 408 may be moved axially relative to the output shaft 414 towards the second low gear 412 such that the detent 428 is positioned in the first groove 418, and the shifting sleeve 408 is locked with the second low gear 412, for example via interlocking teeth. In this way, the shifting sleeve 408 which is rotationally coupled to the output shaft 414 may rotationally couple the second low gear 412 to the output shaft 414. Additionally, the braking mechanism may be deactivated due to the detent 428 being in the first groove 418 such that the springs 432 are relatively less compressed and the first piston 422 and the second piston 424 are allowed to move towards each other, thus relieving pressure on the first brake plate 426 and the second brake plate 427 and halting friction generation. In this way, the first brake plate 426 and the second brake plate 427 are not actuated when the shifting sleeve 408 is in the high speed position or the low speed position.

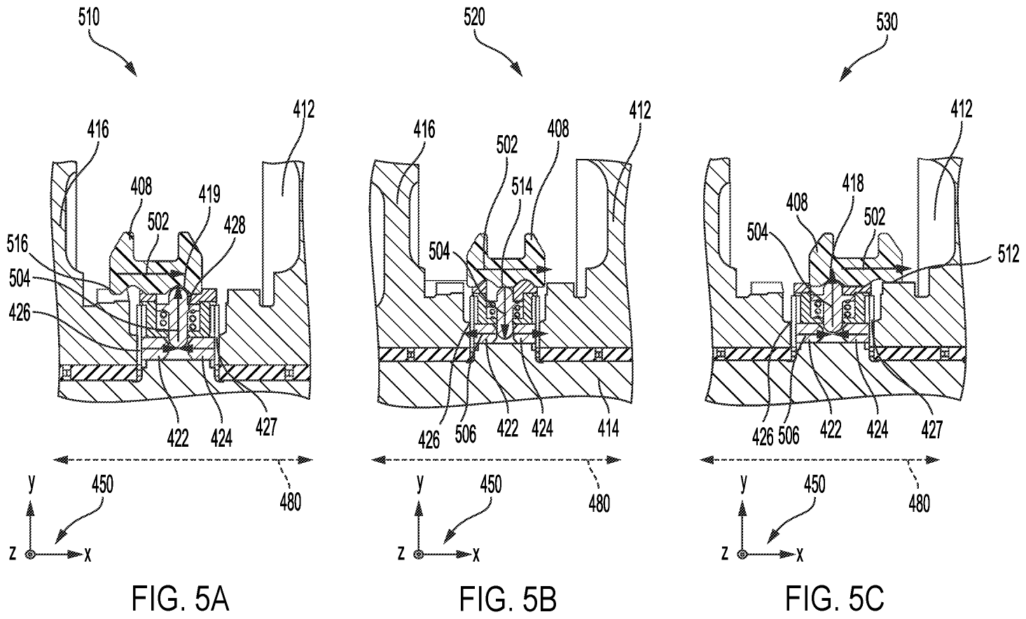

Turning to FIGS. 5A-5C, the clutch with braking mechanism 400 is shown at different positions while transitioning from high gear mode to low gear mode. As such, the clutch with braking mechanism is shown in the high gear mode in first view 510, the shifting position in second view 520, and the low gear mode in the third view 530. Arrows may indicate directions of forces exerted on or by components of the clutch with braking mechanism 400. For example, arrow 502 may indicate a direction of movement of the shifting sleeve 408 due to the shifting fork 438. Arrow 504 may indicate a direction of force exerted on the detent 428 by the shifting sleeve 408 or the springs 432. Arrows 506 may indicate whether the first piston 422 and the second piston 424 arc respectively applying pressure to the first brake plate 426 against the second high gear 416 and to the second brake plate 427 against the second low gear 412.

The high gear mode, as shown in FIG. 5A, may include the detent 428 positioned in the second groove 419 and the shifting sleeve 408 engaged with the second high gear 416. For example, a first protruding portion 516 of the shifting sleeve 408 may include teeth, dogs, or the like that interlock accordingly with the second high gear 416 when in high gear mode. For example, teeth of the first protruding portion 516 may mesh with teeth of the second high gear 416 when the high gearset 236 is engaged. The detent 428 may be pushed by the springs 432 radially away from the axis of rotation 480 (e.g., in the direction indicated by the arrow 504 in FIG. 5A) such that the detent 428 is received by the second groove 419. Due to the end of the detent 428 that is in face sharing contact with the first piston 422 and the second piston 424 having a rounded edge, the detent being positioned in a groove may reduce the thickness between the first piston 422 and the second piston 424 such that the first piston 422 and the second piston 424 may be relatively closer to one another than during shifting (as indicated by arrows 506 in FIG. 5A). In this way, pressure is not applied to the first brake plate 426 or the second brake plate 427, thus the braking mechanism is deactivated in the high gear mode.

The shifting sleeve 408 moving as indicated by arrow 502 causes the clutch with braking mechanism to reach a shifting position as shown in FIG. 5B, wherein neither the second high gear 416 or the second low gear 412 are engaged with the shifting sleeve. As such, the detent 428 is pushed radially towards the second axis of rotation 480 (e.g., in a direction indicated by arrow 504 in FIG. 5B) against the spring force of the springs 432 by contact with a second protruding portion 514 of the shifting sleeve 408. The concave surface of the shifting sleeve 408 between the second protruding portion 514 and the first protruding portion 516 may define the first groove 418. Thus, the first groove 418 may be between the first protruding portion 516 and the second protruding portion 514. The movement of the detent 428 towards the second axis of rotation 480 may increase the thickness thereof between the first piston 422 and the second piston 424, thus pushing the first piston 422 and the second piston 424 axially away from one another (e.g., in directions indicated by arrows 506 in FIG. 5B). Thus, the first piston 422 may push the first brake plate 426 into face sharing contact with the second high gear 416 and the second piston 424 may push the second brake plate 427 into face sharing contact with the second low gear 412 such that the braking mechanism is engaged. As a result, friction may be generated between the first brake plate 426 and the second high gear 416 and between the second brake plate 427 and the second low gear 412, thereby reducing speed differences between the second high gear 416 and the second low gear 412 and allowing for smooth engagement with the second low gear 412 following further movement of the shifting sleeve in the direction indicated by the arrow 502.

As shown in FIG. 5C, the low gear mode may include the detent 428 positioned in the first groove 418 and the shifting sleeve 408 engaged with the second low gear 412. For example, a third protruding portion 512 of the shifting sleeve 408 may include teeth, dogs, or the like that interlock accordingly with the second low gear 412 when in low gear mode, similarly to the way in which the first protruding portion may interlock with the second high gear 416 when in high gear mode. For example, teeth of the third protruding portion 512 may mesh with teeth of the second low gear 412 when the low gearset 232 is engaged. The second groove 419 may be defined by the concave surface between the second protruding portion 514 and the third protruding portion 512. Thus, the second groove 419 may be between the second protruding portion 514 and the third protruding portion 512. Also similar to high gear mode, the detent 428 may be pushed by the springs 432 radially away from the axis of rotation 480 (e.g., in the direction indicated by the arrow 504 in FIG. 5C) such that the detent 428 is received by the first groove 418 and the first piston 422 and the second piston 424 may be relatively closer to one another than during shifting (as indicated by arrows 506 in FIG. 5C). In this way, pressure is not applied to the first brake plate 426 or the second brake plate 427, thus the braking mechanism is deactivated in the low gear mode.

As shown in FIGS. 5A-5C, the axial position of the shifting sleeve 408 may determine the mode of the clutch with braking mechanism 400. The detent 428 may remain in face sharing contact with the shifting sleeve 408 due to the spring force of the springs 432, regardless of the position of the shifting sleeve 408. However, the detent 428 may move radially with respect to the shifting sleeve 408 according to the axial position of the shifting sleeve 408 due to the presence of the first groove 418 and the second groove 419 positioned along the surface of the shifting sleeve 408 which is in face sharing contact with the detent 428. The shifting sleeve 408 may be in a first position (e.g., when in the low gear mode) wherein the detent 428 is received by the first groove 418 and a second position (e.g., when in the high gear mode) wherein the detent 428 is received by the second groove 419. Thus, the shifting sleeve 408 may be a dual-position shifting sleeve. Further, the shifting sleeve 408 may be in an intermediate position between the first position and the second position, for example during shifting. The first piston 422 and the second piston 424 may remain in face sharing contact with the detent 428, regardless of radial movement of the detent 428 due to the curved (e.g., rounded) end of the detent 428. Additionally, surfaces of the first piston 422 and the second piston 424 in face sharing contact with the detent 428 may also be curved to allow for smooth axial movement of the first piston 422 and the second piston 424 as a result of radial movement of the detent 428 to activate and deactivate the braking mechanism. In this way, the axial position of the shifting sleeve 408 may also determine the activation and deactivation of the braking mechanism. The shape of the shifting sleeve 408 (e.g., placement of the first groove 418 and the second groove 419, depth and concavity of the first groove 418 and the second groove 419, width of the shifting sleeve 408 in the x-direction, etc.) may ensure that the braking mechanism is activated during shifting and deactivated when the shifting sleeve 408 is engaged with either the high gearset via the second high gear 416 or the low gearset via the second low gear 412. Further, the shifting sleeve 408 may comprise the first protrusion 516 adapted to rotationally couple the shifting sleeve 408 with the second high gear 416 when in the high speed position, the second protrusion 514 adapted to rotationally couple the shifting sleeve 408 with the output shaft 414, and the third protrusion 512 adapted to rotationally couple the shifting sleeve 408 with the second low gear 412 when in the low speed position.

Turning to FIG. 8, a method is shown for operating a clutch with braking mechanism, such as the clutch with braking mechanism 400 of FIGS. 4A-7B, in a two speed gearbox, such as the gearbox 226 of FIGS. 2-4A. The method 800 may be initiated by a controller communicatively coupled to the clutch with braking mechanism (e.g., controller 12 of vehicle 100 in FIG. 1) and carried out by an actuator (e.g., actuators 18 of FIG. 1), according to instructions in stored memory (e.g., non-volatile memory) of the controller and signals received from vehicle sensors (e.g., sensors 16 of FIG. 1). For example, vehicle sensors detecting a change in driving conditions or user input may prompt the controller to send a signal to a clutch actuation system, which may adjust the clutch with braking mechanism as demanded to achieve a desired mode (e.g., high gear mode or low gear mode) of the clutch with braking mechanism. Specifically, a position of a shifting sleeve (e.g., the shifting sleeve 408) relative to a gear of a low gearset and a gear of a high gearset (e.g., second low gear 412 and second high gear 416) may determine via a detent (e.g., detent 428) positions of pistons (e.g., first piston 422, second piston 424) relative to the aforementioned gears. In some examples, the method 800 may be repeated automatically on a regular interval, with the controller programming including a timed initiation of the method 800. Additionally or alternatively, the method 800 may be triggered by a change in vehicle sensor signals, for example when sensors detect that the vehicle is stationary. The method 800 may be initiated by the controller sending a request to the actuators. Specifically, a request to shift the clutch may be sent by the controller communicatively coupled to a shifting fork that actuates the shifting sleeve.

At 801, it is determined whether the request is to shift to low gear mode, to shift to high gear mode, or to maintain the current mode. For example, if sensors indicate the current mode is the high gear mode and a high gear mode is desired, the request may be to maintain the current mode. In another example, if sensors indicate the current mode is the high gear mode and the low gear mode is desired, the request may be to transition to the low gear mode. In yet another example, if sensors indicate the current mode is the low gear mode and the high gear mode is desired, the request may be to transition to the high gear mode.

If maintaining the current mode is requested (MAINTAINING) at 801, method 800 proceeds to 822, where the current mode is maintained by maintaining a position of the shifting sleeve, and thus maintaining a rotational coupling of the high gearset if the current mode is the high gear mode, or low gearset if the current mode is the low gear mode, to the output shaft via the shifting sleeve.

If shifting to high gear mode is requested (LOW GEAR MODE) at 801, the method 800 proceeds to 802, wherein the shifting sleeve is moved towards the low gearset. For example, in the clutch with braking mechanism 400 of FIGS. 4A-7B, the shifting sleeve 408 may move towards the second low gear 412. In the same example, the shifting sleeve 408 may move in the direction indicated by arrow 502 in FIG. 5A. Thus, the shifting sleeve may be unlocked from the high gearset upon moving towards the low gearset.

At 804, the braking mechanism is activated due to the movement of the shifting sleeve at 802 to the shifting position. For example, movement of the shifting sleeve may cause radially inward movement of the detent relative to an axis of rotation of the output shaft, thus moving the pistons axially away from one another and towards the gears. As shown in FIG. 5B, the detent 428 and the first piston 422 and second piston 424 may follow paths indicated by the arrow 504 and the arrows 506, respectively.

Reduction in rotational speed difference between gears occurs at 806 due to the braking mechanism being activated during shifting. In the shifting position, the pistons may press the brake plates against gears of the high gearset and the low gearset, thereby reducing a difference in speeds thereof. For example, the rotational speeds of a first gear of the high gearset and a second gear of the low gearset, wherein the first gear and the second gear are arranged about the output shaft, may be synchronized such that they are approximately the same. In some examples, activating the braking mechanism results in the high speed gearset and the low speed gearset being rotationally stationary prior to engaging. In this way, clashing upon engagement in subsequent steps of the method 800 and wear of the shifting sleeve may be reduced.

At 808, the braking mechanism is deactivated. Deactivating the braking mechanism may include the detent moving into a groove of the shifting sleeve allowing for pistons to move back towards one another, thereby removing pressure that generates friction between the protrusion of the output shaft, the brake plates, and the gears. For example, as shown in FIG. 5B, the shifting sleeve 408 may move according to the arrow 502, the detent 428 may move away from the axis of rotation 480 in the direction shown by arrow 504, and the first piston 422 and second piston 424 may move towards each other in directions indicated by the arrows 506. In this way, the pistons do not apply pressure to the brake plates against the gears such that friction is not generated upon deactivation of the braking mechanism.

At 810, the shifting sleeve is locked with the low gearset. For example, as shown in FIG. 5C, the shifting sleeve 408 may lock (e.g., engage) with the second low gear 412 (e.g., via interlocking teeth) such that the shifting sleeve 408 rotationally couples the second low gear 412 to the output shaft 414. In this way, the output shaft may be engaged with the low gearset such that power may flow from the input shaft to the output shaft via the low gearset, as shown in FIG. 3B.

If shifting to high gear mode is requested (HIGH GEAR MODE) at 801, the shifting sleeve is moved towards the high gearset at 812. For example, the shifting sleeve 408 of clutch with braking mechanism 400 shown in FIGS. 4A-7B may move axially towards the second high gear 416. Thus, the shifting sleeve may be unlocked from the second low gear 412. The shifting sleeve may be moved in a directly opposite direction from the direction described at 802.

At 814, the braking mechanism is activated due to the movement of the shifting sleeve at 812. For example, movement of the shifting sleeve may cause radial movement of the detent relative towards an axis of rotation of the output shaft, thus moving pistons axially away from one another. As the pistons are moved away from one another, each piston may press a brake plate between the piston and a gear. For example, a first piston may press a first brake plate between the first piston and a first gear of the high gearset, and a second piston may press a second brake plate between the second piston and a second gear of the low gearset. The braking mechanism may be activated in a similar manner when transitioning from low gear mode to high gear mode as to transitioning from high gear mode to low gear mode. As such, as shown in FIG. 5B, the detent 428 and the first piston 422 and second piston 424 may follow paths indicated by the arrow 504 and the arrows 506, respectively, though the shifting sleeve 408 may be moved opposite the arrow 502.

Reduction in rotational speed difference between gears occurs at 816 due to the braking mechanism being activated during shifting. In the shifting position, the pistons may press the brake plates against gears of the high gearset and the low gearset as described above in regards to 814, thereby reducing a difference in speeds thereof. Thus, clashing upon engaging with the high gearset in subsequent steps of the method 800 may be reduced, reducing wear on the shifting sleeve.

At 818, the braking mechanism is deactivated by the movement of the detent into a groove of the shifting sleeve allowing for pistons to move back towards one another, thereby removing pressure that generates friction at surfaces of the brake plates.

At 820, the shifting sleeve is locked with the high gear. For example, the shifting sleeve 408 may be locked with the second high gear 416 via interlocking teeth such that the shifting sleeve 408 rotationally couples the second high gear 416 to the output shaft 414. In this way, the output shaft may be engaged with the high gearset such that power may flow from the input shaft to the output shaft via the high gearset, as shown in FIG. 3A.

FIGS. 4A-7B show example configurations with relative positioning of the various components; though other relative dimensions may be used. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Additionally, elements co-axial with one another may be referred to as such, in one example. Further, elements shown intersecting one another may be referred to as intersecting elements or intersecting one another, in at least one example. Further still, an element shown within another element or shown outside of another element may be referred as such, in one example. In other examples, elements offset from one another may be referred to as such.

Features described as axial may be approximately parallel with an axis referenced unless otherwise specified. As used herein, the terms “approximately” is construed to mean plus or minus five percent of the range unless otherwise specified. Features described as counter-axial may be approximately perpendicular to the axis referenced unless otherwise specified. Features described as radial may circumferentially surround or extend outward from an axis, such as the axis referenced, or a component or feature described prior as being radial to a referenced axis, unless otherwise specified.

Features described as longitudinal may be approximately parallel with an axis that is longitudinal. A lateral axis may be normal to a longitudinal axis. Features described as lateral may be approximately parallel with the lateral axis. A vertical axis may be normal to a lateral axis and a longitudinal axis. Features described as vertical may be approximately parallel with a vertical axis.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A clutch comprising:
a dual-position shifting sleeve in face sharing contact with a radially aligned spring loaded detent, wherein the shifting sleeve includes a first groove adapted to receive the detent in a high speed position and a second groove adapted to receive the detent in a low speed position; and
a first axially aligned piston and a second axially aligned piston adapted to actuate a first brake plate and a second brake plate, respectively, when the shifting sleeve is in an intermediate position between the high speed position and the low speed position.

2. The clutch of claim 1, wherein the clutch is rotationally coupled to an output shaft of a gearbox.

3. The clutch of claim 1, wherein the first brake plate is interposed between a first gear and the first piston and the second brake plate is interposed between a second gear and the second piston.

4. The clutch of claim 1, further comprising a plurality of spring loaded detents, wherein the plurality of spring loaded detents are radially arranged about a shaft on which the clutch is positioned and each of the plurality of spring loaded detents is in face sharing contact with two pistons.

5. The clutch of claim 1, wherein the dual-position shifting sleeve is actuated by a shifting fork configured to be received by a recess in the shifting sleeve, and wherein the shifting sleeve is not rotationally coupled to the shifting fork.

6. The clutch of claim 1, wherein the first brake plate and the second brake plate are not actuated when the shifting sleeve is in the high speed position or the low speed position.

7. The clutch of claim 1, wherein radial movement of the detent causes axial movement of the first piston and the second piston to actuate the first brake plate and the second brake plate, respectively.

8. The clutch of claim 1, wherein axial movement of the shifting sleeve is translated to radial movement of the detent, and wherein the radial movement of the detent is translated to axial movement of the first piston and the second piston.

9. The clutch of claim 1, wherein the shifting sleeve comprises a first protruding portion adapted to rotationally couple the shifting sleeve with a first gear when in the high speed position, a second protruding portion adapted to rotationally couple the shifting sleeve with a shaft, and a third protruding portion adapted to rotationally couple with a second gear when in the low speed position.

10. The clutch of claim 9, wherein the first groove is between the first protruding portion and the second protruding portion and the second groove is between the second protruding portion and the third protruding portion.

11. A gearbox, comprising:
a high speed gearset comprising a first high gear and a second high gear;
a low speed gearset comprising a first low gear and a second low gear;
an input shaft, wherein the first high gear and the second high gear are radially arranged about and rotationally coupled to the input shaft;
an output shaft, wherein the second high gear and the second low gear are radially arranged about the output shaft;
a clutch configured to engage either the high speed gearset or the low speed gearset by rotationally coupling the second high gear or the second low gear, respectively, with the output shaft, the clutch comprising a shifting sleeve including a first groove and a second groove, and a detent, wherein the low speed gearset is engaged when the first groove receives the detent, the high speed gearset is engaged when the second groove receives the detent, and a braking mechanism is activated when neither the high speed gearset or the low speed gearset are engaged.

12. The gearbox of claim 11, wherein the shifting sleeve has a first protruding portion having teeth adapted to mesh with teeth of the second high gear when the high speed gearset is engaged, a second protruding portion having teeth adapted to mesh with teeth of the output shaft, and a third protruding portion having teeth adapted to mesh with teeth of the second low gear when the low speed gearset is engaged.

13. The gearbox of claim 11, wherein the braking mechanism reduces a difference in rotational speed of the second high gear and the second low gear.

14. The gearbox of claim 11, wherein the braking mechanism is actuated by axial movement of the shifting sleeve.

15. The gearbox of claim 11, wherein the braking mechanism reduces a difference in rotational speed of the input shaft until the input shaft is rotationally stationary.

16. The gearbox of claim 11, wherein the clutch is adapted to shift when the output shaft is rotationally stationary.

17. A method, comprising:
in response to a request to shift a clutch to a low gear mode, moving a shifting sleeve of the clutch towards a low speed gearset and away from a high speed gearset;
activating a braking mechanism to reduce a rotational speed difference between gears of the high speed gearset and the low speed gearset;
deactivating the braking mechanism; and
engaging the low speed gearset by locking the shifting sleeve with the low speed gearset.

18. The method of claim 17, wherein the method further comprises:
in response to a request to shift the clutch to a high gear mode, moving the shifting sleeve of the clutch towards the high speed gearset and away from the low speed gearset;
activating the braking mechanism to reduce a rotational speed difference between gears of the high speed gearset and the low speed gearset;
deactivating the braking mechanism; and
engaging the low speed gearset by locking the shifting sleeve with the low speed gearset.

19. The method of claim 18, wherein activating the braking mechanism results in the high speed gearset and the low speed gearset being rotationally stationary prior to engaging.

20. The method of claim 18, wherein the request to shift the clutch is sent by a controller communicatively coupled to a shifting fork that actuates the shifting sleeve.
